(19) United States
(12) Patent Application Publication
(10) Pub. No.: US 2014/0183121 A1
(43) Pub. Date: Jul. 3, 2014

(54) GROUNDING OF A FILTER BY MEANS OF AN ELECTRICALLY CONDUCTIVE CONDUCTOR TRACE ON THE FILTER ELEMENT

(71) Applicant: Martin Beyer, Marbach (DE)

(72) Inventor: Martin Beyer, Marbach (DE)

(73) Assignee: ROBERT BOSCH GMBH, Stuttgart (DE)

(21) Appl. No.: 14/239,169

(22) PCT Filed: Jun. 12, 2012
(86) PCT No.: PCT/EP2012/061083

§ 371 Date: Feb. 17, 2014

(30) Foreign Application Priority Data
Aug. 17, 2011 (DE) 10 2011 081 143.5

(51) Int. Cl. H05F 3/00; B01D 35/14

(52) U.S. Cl. CPC H05F 3/00; B01D 35/14
USPC 210/243; 29/825

(57) ABSTRACT

The invention relates to a filter (1) for filtering a liquid (3). The filter (1) comprises a filter element (5) that is designed to clean the liquid (3) of undesired particles. The filter element (5) is arranged between a first end cap (7) and a second end cap (9). The filter element (5), the first end cap (7) and the second end cap (9) are designed to be electrically nonconductive. An electrically conductive conductor trace (11) is arranged on the filter element (5) in order to dissipate electric charge.

### BACKGROUND OF THE INVENTION

If a liquid flows through a narrow gap or through a component having a small cross section, friction can occur between the component and the liquid. In particular at high flow velocities of the liquid, this can lead to a charge separation and therefore to an electrostatic charging of the component through which the liquid flows.

It is important to avoid electrostatic discharges (ESD) particularly in environments possibly comprising ignitable components, such as, for example, in a fuel tank. In addition, an electrostatic discharge has to be avoided in order to avoid an undesirable influence from surrounding electrical devices. Furthermore, an electrostatic discharge should be prevented in order to avoid wear to material, so-called “pin holing”, as a result of repeated spark discharge at the same location.

In the case of filters, in particular fuel filters, the prevention of electrostatic discharge is achieved by virtue of the fact that the individual components of the filter, such as filter housing, filter paper or filter end caps, are embodied in a conductive manner such that the developing charges can be discharged. Depending on safety requirements, a portion of the components or all components can be embodied in a conductive manner.

The conductive embodiment of the individual filter components can however be expensive. In addition, the filter element has to be varied and adapted in the configuration thereof depending on which components are embodied in a conductive manner.

### SUMMARY OF THE INVENTION

A need for an improved configuration of the filter can therefore exist which makes a more cost effective production and a universal applicability of the filter possible.

Features, details and possible advantages of a device according to the embodiments of the invention are discussed below in detail.

According to a first aspect of the invention, a filter for filtering a liquid is disclosed. The filter comprises a filter element which is designed to clean the liquid of undesired particles. In addition, the filter comprises a first end cap and a second end cap. The filter element is disposed between the first and the second end cap. The filter element, the first end cap and the second end cap are designed to be electrically nonconductive. An electrically conductive conductor is arranged on the filter element in order to dissipate electric charge.

In other words, the concept of the present invention is based on providing a filter, the filter cartridge of which comprises electrically nonconductive materials and in which filter a thin electrically conductive conductor trace, such as a wire, is provided on the filter cartridge in order to dissipate electrostatic charge. In this way, uncontrolled electrostatic charges are avoided in a cost saving and technically uncomplicated manner. On the one hand, costs are therefore saved on conductive materials in the filter. On the other hand, an adaptation of the filter and the constituent parts thereof to the respective safety requirements is unnecessary because the electrically conductive conductor trace can be mounted to all safety-relevant components of the filter. At least the filter element can thus be universally manufactured and if necessary provided with a conductor trace so that a variance of the filter element is not necessary.

The filter can be embodied as a fuel filter for filtering fuel, for example gasoline. The filter can be used in a motor vehicle and be disposed between a fuel pump and a fuel injection system of a combustion engine. In particular, the filter can be disposed inside or outside the fuel tank. Said filter can thus be disposed in the fuel pump reservoir or in a fuel delivery module or on or under a tank flange. The filter can additionally be embodied as a filter for life, i.e. the filter can be embodied such that, after an initial installation, it can remain functionally operative at the location of installation without maintenance requirements.

The filter element, also referred to as the filter cartridge, is designed to clean the liquid, in particular a fuel, of undesired particles. The filter element can, for example, comprise paper and, e.g., be embodied as a folded hollow cylinder. A cross section perpendicular to the longitudinal axis of the filter element can, for example, be designed star-shaped or zigzag-shaped. The filter element can further comprise a support structure which, e.g., supports the filter material from the inside. The liquid to be cleaned can, for example, flow from the outside, e.g., radially into the inside of the filter element. A channel situated inside the filter element can further direct the filtered liquid. For example, filtered fuel can be directed from the filter to a combustion engine.

The filter further comprises a first and a second end cap, also referred to as end plate. The filter element is embedded between the first and the second end cap. In so doing, the first and the second end cap are impermeably connected to the filter element. The filter element is, for example, adhesively bonded to the end caps, or the end caps are fused to the filter element. The first end cap can thereby have an opening which is connected to a cavity inside the filter element and through which the filtered liquid can be led out of the filter.

The filter element and the end caps are designed to be electrically nonconductive. That means the filter element, the first end cap and the second end cap comprise, for example, nonconductive or, respectively, insulating materials. Said materials can, e.g., be nonmetals, hydrocarbons, plastics and organic compounds. The filter element can, e.g., be made from paper or cardboard. The electrical conductivity of the nonconductive materials can, e.g., be less than 10⁻⁸ Siemens per meter.

An electrically conductive conductor trace is arranged on the filter element in order to dissipate electric charge. The conductor trace, also referred to as conductor or conduction band, can thereby, e.g., rest directly against the filter element and, e.g., be wound onto the filter element. The dimensions of the cross section of the conductor trace can be small in relation to the extension of said conductor trace along the longitudinal axis thereof. The electrically conductive conductor trace can be a long, thin and flexible structure, which, e.g., retains the form thereof after a bending procedure. For example, the electrically conductive structure can be embodied as wire.

The electrically conductive conductor trace can be spaced apart from the filter element at a, e.g. slight, distance. That means the conductor trace can be wound around the filter element such that a small gap exists between the electrically conductive conductor trace and the filter element. Alternatively, the conductor trace can fit snugly against the filter element. If, for example, charges occur when the liquid passes through the filter, said charges can, e.g., collect on the filter element, in particular on the filter paper. Due to the conductor trace resting, e.g., directly on the filter element, said charges are discharged to a ground or are respectively grounded directly after they arise. In this way, it is ensured that sparks do not occur or that an uncontrolled electrostatic discharge does not take place. This is particularly important when the filter is disposed in a fuel tank.

According to one exemplary embodiment of the invention, the electrically conductive conductor trace is embodied as electrically conductive wire. In so doing, the wire can be dimensioned considerably larger in a longitudinal direction than the dimension thereof in a plane perpendicular to the longitudinal direction of the wire. The wire can be configured to be thin, long and flexible and to comprise conductive metal or conductive plastic. The wire can be embodied as flat wire, profile wire, rectangular wire or as wire having a round or, respectively, annular cross section. The wire can, for example, comprise iron, copper, brass, aluminum, silver, gold, stainless steel or combinations of these materials. Furthermore, the wire can comprise copper alloys and magnesium. The use of a wire is particularly cost effective, and the wire can be wound with little effort and in a technically simple manner around the filter element.

According to a further exemplary embodiment of the invention, the wire is wound helically around the filter element. When the wire is wound helically around the filter element, one end of the wire can be attached to an end cap and the other end of the wire can be connected to a ground connection, in a motor vehicle to the vehicle body or to the negative pole of an energy source.

According to a further exemplary embodiment of the invention, the electrically conductive conductor trace is designed in a spring-like manner. The wire is, for example, embodied as a spring, i.e. the electrically conductive conductor trace or rather the wire can be pre-tensioned, yield under load and return to the original configuration after being released. In a spring-like or pre-tensioned configuration of the electrically conductive conductor trace, it can be ensured that said electrically conductive conductor trace rests against the filter element.

According to a further exemplary embodiment of the invention, the electrically conductive conductor trace has a first end region which can be connected to an electrical ground connection. In a motor vehicle, the electrical ground connection can, for example, be the negative pole of an electrical voltage source of the vehicle or can be the vehicle body.

According to a further exemplary embodiment of the invention, the first end region is configured as a helical spring. In so doing, the diameter of the helical spring is smaller than a diameter of the filter element. The helical spring is or can be connected to the electrical ground connection and if applicable be pre-tensioned; thus enabling different distances between the filter element and a connection to the electrical ground connection to be bridged, said different distances resulting, for example, from manufacturing tolerances. To this end, the helical spring can be embodied as a cylindrical coil spring, in particular as a wound torsion spring having at least one full winding.

According to another exemplary embodiment of the invention, the electrically conductive conductor trace has a second end region. In so doing, a first attachment device is provided on the first end cap and a second attachment device on the second end cap. The first end region is attached to the first attachment device and the second end region of the electrically conductive conductor trace to the second attachment device.

According to a further exemplary embodiment of the invention, the first attachment device is designed as a clamping device or as a pin. The second attachment device can likewise be designed as a clamping device or as a pin.

By means of the attachment devices, the end regions of the electrically conductive conductor trace can be fixed, for example, prior to or after winding the electrically conductive conductor trace onto the filter element. A tight winding of the electrically conductive conductor trace around the filter element can, for example, be ensured by fixing the electrically conductive conductor trace to the filter element. The first and/or second end region can, for example, be clamped and or adhesively bonded in the first or second attachment device. In addition, the first and/or second end region of the electrically conductive conductor trace can be wound around a pin. The pin can thereby be embodied, for example, as an elevation or projection on the end cap.

According to a further exemplary embodiment of the invention, the filter additionally comprises a housing in which the filter element is disposed. A recess is provided in the housing, by means of which recess a ground connection can be connected to the first end region of the electrically conductive conductor trace. The housing can likewise consist of an electrically nonconductive material or comprise an electrically nonconductive material. The electrically conductive conductor trace can additionally extend along the surface of the housing. In so doing, said electrically conductive conductor trace can be arranged on the inside, i.e. on the side of the housing facing the filter element, or on the outside of the housing. In this way, the danger of sparks forming due to electrostatic charge is further reduced.

A sealing element, which impermeably separates the filter and the housing from the surrounding environment can be provided between the filter element and the housing. The sealing element can, for example, be disposed on the first end cap so that a pipe can be guided by means of a recess in the housing through the sealing element to the cavity inside the filter element. From there, the filtered liquid can travel to its destination.

The housing can further have a feed opening through which the non-filtered liquid, for example non-filtered fuel, can be taken into the filter and fed into the region between housing wall and filter element.

According to a second aspect of the invention, a method for manufacturing a filter for filtering a liquid is disclosed. The method comprises the following steps: disposing an electrically nonconductive filter element between a first and a second electrically nonconductive end cap and winding an electrically conductive conductor trace around the filter element in a helical manner. The order of the steps can vary. For example, the electrically conductive conductor trace can be initially wound around the filter element and subsequently the filter can be embedded between the end caps.

### BRIEF DESCRIPTION OF THE DRAWINGS

Further features and advantages of the present invention will become apparent to the person skilled in the art from the following description of exemplary embodiments, which are however not to be interpreted so as to limit the scope of the invention, with reference to the attached drawings.

FIG. 1 shows a cross section through a filter according to a first exemplary embodiment of the invention.

FIG. 2 shows a top view of a first end cap of the filter according to the first exemplary embodiment of the invention.

FIG. 3 shows a cross section through a filter according to a second exemplary embodiment of the invention.

### DETAILED DESCRIPTION

All figures are only schematic depictions of inventive devices or of the constituent parts thereof in accordance with exemplary embodiments of the invention. Particularly spacing distances and size relations are not reflected true to scale in the figures. Corresponding elements are provided with the same reference numerals in the different drawings.

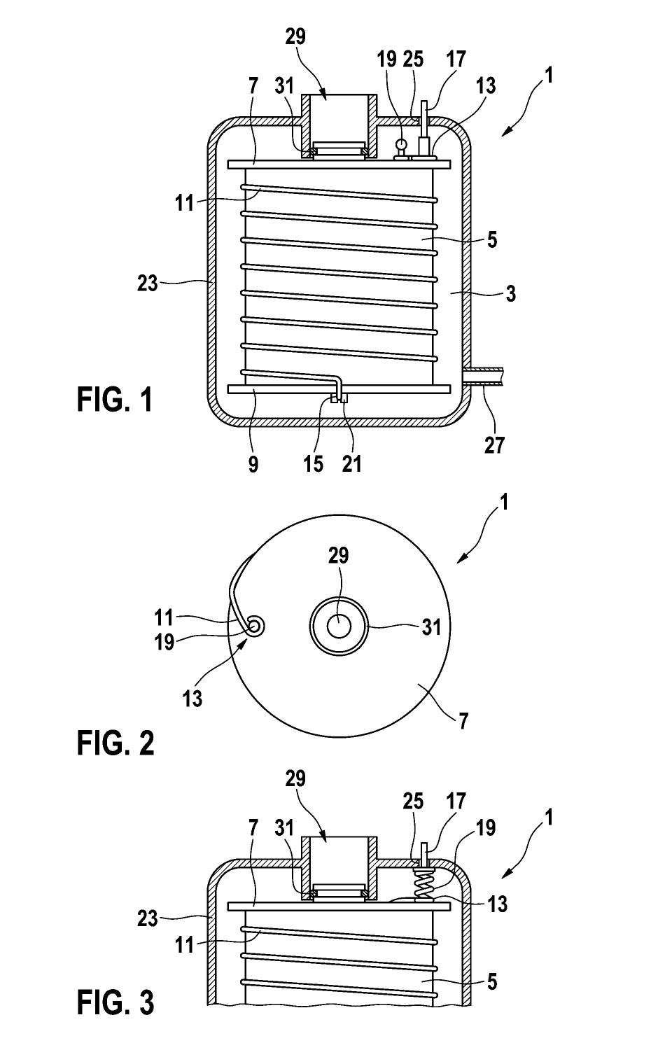

In FIG. 1, a cross section of a filter 1, in particular of a fuel filter is depicted. The filter comprises a filter element 5 which is designed to clean a liquid 3 of undesired particles. The filter element 5 can, for example, be folded filter paper, if applicable with an inner support structure. The filter element 5 is disposed between a first end cap 7 and a second end cap 9. The end caps 7, 9 impermeably close off the filter element 5 with respect to the liquid 3 in the intermediate space between a housing 23 and the filter element 5. In so doing, the liquid 3 must pass through the filter element 5 before entering into a cavity within said filter element 5 and from there being guided through a discharge opening, if need be via pipes to the destination thereof. In the case of a fuel filter, the fuel is guided via the discharge opening 29 to a fuel injection system of a combustion engine. The fuel filter can, e.g., be disposed in a fuel tank, in particular in a storage pot in the fuel tank, and be supplied with fuel via a fuel supply opening 27.

The constituent parts of the filter 1, such as filter element 5, first end cap 7, second end cap 9 and if applicable the housing 23, are designed to be electrically nonconductive as this makes a cost effective and technically simple production of the filter 1 possible.

When liquid passes through the filter 1 and in particular the filter element 5, friction can occur between the filter 1 and the liquid 3. As a result, charges are separated and the filter 1 is electrostatically charged. In order to prevent sparks from forming, an electrically conductive conductor trace 11 is directly disposed on the filter element 5 and is grounded at a ground connection 17, which, for example, is connected to a negative pole of a voltage source or, in the case of a fuel filter, to the vehicle body. In this way, it is ensured that the electrically nonconductive constituents of the filter 1 are grounded.

In this case, the electrically conductive conductor trace 1 is embodied as a wire and is wound helically around the filter element 5. In order to attach the electrically conductive trace 11 to the filter element 5, a first attachment device 19 is provided on the first end cap 7. Said attachment device can, e.g., be embodied as a pin or as a clamping device. In the exemplary embodiment in FIG. 1, the first attachment device 19 is embodied as a pin, around which a first end region 13 of the electrically conductive conductor trace 11 is wound. This is shown particularly in the top view of the first end cap 7 in FIG. 2.

In addition, a second attachment device 21 is provided on the second end cap 9, which likewise can be embodied as a clamping device or pin. In the exemplary embodiment in FIG. 1, the second attachment device 21 is embodied as a clamping device. In so doing, a second end region 15 of the electrically conductive conductor trace 11 is clamped or clipped into the second attachment device 21.

The housing 23 surrounding the filter element 5 further comprises a recess 25, through which the ground connection 17 can be guided to the first end region 13 of the electrically conductive conductor trace 11. A sealing element 31, e.g. a rubber seal, is provided between the housing 23 and the filter element 5, in particular between the housing 23 and the first end cap 7. Said seal ensures that only filtered liquid 3 can pass through the discharge opening 29.

As is shown in FIG. 3, the first end region 13 of the electrically conductive conductor trace 11 can be embodied as a helical spring. The helical spring can, for example, be pre-tensioned. This embodiment ensures that differences in the distance between the housing 23 or, respectively, the ground connection 17 and the surface of the first end cap 7, which occur, e.g., as a result of manufacturing tolerances, are compensated. That means, for the case that the distance between the first end cap 7 and the ground connection 17 is larger than usual, the pre-tensioned helical spring expands until it reaches the ground connection 17. The embodiment of the first end region 13 of the electrically conductive conductor trace 11 as a helical spring makes it possible to dispense with additional spring elements for compensating for manufacturing tolerances. In so doing, costs are saved and the amount of work is reduced.

When manufacturing the filter 1, the electrically conductive conductor trace 11, also referred to as spring wire, can be directly disposed on and attached to the filter element after a bending procedure. As a result, such a configuration prevents the electrically conductive conductor trace 11 from having to be delivered as bulk material; thus enabling a large amount of work to be avoided.

A particularly cost effective solution for grounding the filter element 5 is provided by the inventive configuration of the filter 1. Furthermore, thanks to the inventive configuration of the filter 1, it is ensured that the constituent parts of the filter 1, in particular the filter element 5, do not have to be altered on account of grounding.

It is noted in conclusion that expressions such as “comprising” or something similar should not exclude further elements or steps from being provided. In addition, it should be pointed out that “one” or “a” does not exclude a plurality. Moreover, the features described in connection with the different embodiments can be arbitrarily combined with each other. It is noted further that the reference numerals in the claims are not to be interpreted so as to limit the scope of the claims.

1. A filter (1) for filtering a liquid (3), said filter (1) comprising:
a filter element (5) for cleaning the liquid (3) of undesired particles;
a first end cap (7), and
a second end cap (9),
wherein the filter element (5) is arranged between the first end cap (7) and the second end cap (9);
characterized in that
the filter element (5), the first end cap (7) and the second end cap (9) are electrically nonconductive; and in that an electrically conductive conductor trace (11) is arranged on the filter element (5) in order to dissipate electric charge.

2. The filter (1) according to claim 1,
wherein the electrically conductive conductor trace (11) is an electrically conductive wire.

3. The filter (1) according to claim 2,
wherein the wire is wound helically around the filter element (5).

4. The filter (1) according to claim 1,
wherein the electrically conductive conductor trace (11) is configured in a spring-like manner.

5. The filter (1) according to claim 1,
wherein the electrically conductive conductor trace (11) comprises a first end region (13); and
wherein the first end region (13) is configured to be connected to a ground connection (17).

6. The filter (1) according to claim 5, wherein the first end region (13) is a helical spring; and
wherein a diameter of the helical spring is smaller than a diameter of the filter element.

7. The filter according to claim 5,
wherein a first attachment device (19) is provided on the first end cap (7);
wherein the electrically conductive conductor trace (11) comprises a second end region (15);
wherein a second attachment device (21) is provided on the second end cap (9);
wherein the second end region (15) is attached to the second attachment device (21); and
wherein the first end region (13) is attached to the first attachment device (19).

8. The filter (1) according to claim 7,
wherein the second attachment device (21) is a clamping device or a pin; and
wherein the first attachment device (19) is a clamping device or a pin.

9. The filter (1) according to claim 5, comprising further a housing (23);
wherein the filter element (5) is disposed in the housing (23); and
wherein a recess (25) is provided in the housing (23), by means of which recess the ground connection (17) can be connected to the first end region (13) of the electrically conductive conductor trace (11).

10. A method for manufacturing a filter (1) for filtering a liquid (3) according to claim 1, said method comprising the following steps:
disposing the electrically nonconductive filter element (5) between the first electrically nonconductive end cap (7) and the second electrically nonconductive end cap (9); and
winding the electrically conductive conductor trace (11) around the filter element (5) in a helical manner.
